(19) United States
(12) Patent Application Publication
(10) Pub. No.: US 2021/0209517 A1
(43) Pub. Date: Jul. 8, 2021

(54) SYSTEM FOR OPERATING COMMERCIAL VEHICLES

(71) Applicant: Nissan Motor Co., Ltd., Yokohama-shi, Kanagawa (JP)

(72) Inventors: Seiji SHIMODAIRA, Kanagawa (JP); Hiroya FUJIMOTO, Kanagawa (JP); Yasuhisa KISHI, Kanagawa (JP)

(21) Appl. No.: 17/056,443

(22) PCT Filed: Jun. 14, 2019
(86) PCT No.: PCT/IB2019/000626

§ 371 Date: Nov. 18, 2020

(30) Foreign Application Priority Data
Jun. 18, 2018 (JP) 2018-115126

(51) Int. Cl. G06Q 10/02; G08G 1/00; G06Q 30/02; G06Q 50/30

(52) U.S. Cl. CPC G06Q 10/02; G06Q 50/30; G06Q 30/0284; G08G 1/202

(57) ABSTRACT

A commercial vehicle operation system is provided with a server that can communicate with an assistive work service for providing vehicles and a vehicle that is not equipped with an assistant's terminal or assistive equipment. The server selects a candidate vehicle and instructs a vehicle to be dispatched to a user. The server is provided with a user information acquisition unit that acquires user information including at least necessity of the assistive work from a user terminal possessed by the user, and when there is a request for the assistive work in the user information, the assistive work service providing vehicle is dispatched.

### CROSS-REFERENCE TO RELATED APPLICATIONS

This application is a U.S. national stage application of International Application No. PCT/IB2019/000626, filed on Jun. 14, 2019.

### TECHNICAL FIELD

The present invention relates to a commercial vehicle operation system that presents to a user terminal a vehicle, which is equipped with an assistant's terminal or assistive equipment that executes assistive work, and that can provide an assistive work service, when a request for assistive work appears in user information.

### BACKGROUND INFORMATION

A conventional commercial vehicle operation system is known from Japanese Laid-Open Patent Application No. 2016-91411 (Patent Document 1), in which an operation system dispatches a manned operation vehicle with a dedicated driver, such as a taxi, or an operation system dispatches an unmanned operation vehicle by means of an autonomous driving function.

### SUMMARY

However, there may be cases in which a request to dispatch an unmanned operation vehicle cannot be fulfilled, even if the user in need of assistive work is willing to ride in an unmanned operation vehicle, because an assistant who can provide the assistive work service is not available, or assistive equipment is not in place. In addition, the problem may arise that even in the case of a manned operation vehicle, if the driver is a woman or an elderly person considered to be relatively infirm, an opportunity to receive assistive service will be lost. Further, there is the problem that if a vehicle provided with assistive equipment or a driver that can serve as an assistant is dispatched to a user who does not require assistive work, assistive work service will not be provided to other users in need of such assistive service.

The problem to be solved by the present invention is to provide a commercial vehicle operation system that can dispatch a commercial vehicle to the right person in the right place based on whether user assistance is required, in order to suppress wasteful energy consumption.

A commercial vehicle operation system according to the present invention comprises a server that is able to communicate with a vehicle capable of providing assistive work, and a vehicle not provided with an assistant's terminal and assistive equipment, and that selects a candidate vehicle in accordance with user information, which includes whether assistive work is required based on inputs to a user terminal possessed by a user in order to issue an instruction to dispatch a vehicle to the user.

By means of the present invention, when a user issues a use request notification, the server is notified in advance regarding whether assistive work will be required; it thus becomes possible to dispatch a vehicle capable of providing assistive work that meets the needs of the user. It thereby becomes possible to dispatch a vehicle that provides the assistive work service desired by a user who requires assistance getting into and out of the vehicle, and, conversely, to dispatch a vehicle that does not provide an assistive work service to a user who does not require assistance getting into and out of the vehicle. Therefore, by means of the commercial vehicle operation system according to the present invention, it is possible to promote customer satisfaction with the system, and since it is possible to dispatch a commercial vehicle to the right person in the right place based on whether assistive work is required, there is the effect that wasteful energy consumption can be suppressed.

### BRIEF DESCRIPTION OF THE DRAWINGS

Referring now to the attached drawings which form a part of this original disclosure.

FIG. 1 is a block diagram explaining a configuration of a commercial vehicle operation system according to an embodiment of the present invention.

FIG. 2 is a flowchart illustrating a control procedure of the commercial vehicle operation system according to the embodiment of the present invention.

FIG. 3 is a first flowchart illustrating a detailed control procedure relating to the process flow for the extraction of a candidate vehicle, as a subroutine process of Step S113 of FIG. 2.

FIG. 4 is a second flowchart illustrating a detailed control procedure when a user desires assistance and carpooling, as a subroutine process of Step S113 of FIG. 2.

FIG. 5 is a third flowchart illustrating a detailed control procedure when a user desires assistance but does not desire carpooling, as a subroutine process of Step S113 of FIG. 2.

FIG. 6 is a fourth flowchart illustrating a detailed control procedure when a user desires the dispatching of an unmanned operation vehicle and assistance during boarding and deboarding but does not desire carpooling, as a subroutine process of Step S113 of FIG. 2.

FIG. 7 is a fifth flowchart illustrating a detailed control procedure when a user desires the dispatching of an unmanned operation vehicle and assistance only during boarding but does not desire carpooling, as a subroutine process of Step S113 of FIG. 2.

FIG. 8 is a sixth flowchart illustrating a detailed control procedure when a user desires the dispatching of an unmanned operation vehicle and assistance only during deboarding but does not desire carpooling, as a subroutine process of Step S113 of FIG. 2.

FIG. 9 is a seventh flowchart illustrating a detailed control procedure when a user desires carpooling but does not desire assistance, as a subroutine process of Step S113 of FIG. 2.

FIG. 10 is an eighth flowchart illustrating a detailed control procedure when a user desires neither assistance nor carpooling, as a subroutine process of Step S113 of FIG. 2.

FIG. 11 is a screen presented to a user terminal when requests for user assistance and carpooling are confirmed.

FIG. 12 is a screen presented to a user terminal when a desired commercial vehicle to be dispatched is selected.

FIG. 13 is a screen for presenting a carpooling consultation notification to a preceding user's terminal.

### DETAILED DESCRIPTION OF EMBODIMENTS

An embodiment of the present invention will be described below based on the drawings.

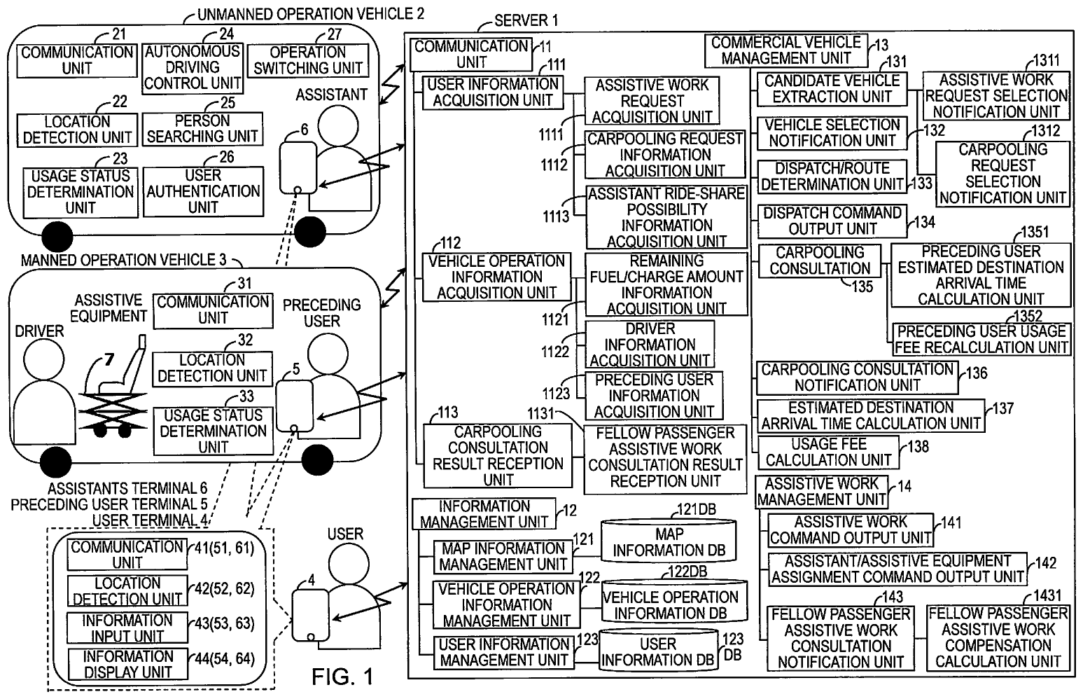

FIG. 1 is a block diagram explaining the configuration of a commercial vehicle operation system according to an embodiment of the present invention. The commercial vehicle operation system according to the present embodiment includes a server 1, an unmanned operation vehicle 2 and a manned operation vehicle 3 to be used by a user, a user terminal 4 possessed by a user, a preceding user terminal 5 possessed by a preceding user, an assistant's terminal 6 possessed by an assistant that assists the user, and assistive equipment 7 capable of carrying out assistive work in the same manner as an assistant. The unmanned operation vehicle 2 is a commercial vehicle that can be driven autonomously without a driver, and the manned operation vehicle 3 is a commercial vehicle that is driven by a dedicated driver. The assistant is an employee that carries out assistive work, such as assisting the user in getting in and getting out of the vehicle, loading and unloading luggage, and the like. The assistant's terminal 6 is a communication device possessed by the assistant and that communicates with the server 1 to receive a command for assistive work, or the like. Examples of the assistive equipment 7 include passenger lifts for allowing the user get into and out of a seat in the commercial vehicle, or a ramp which a user in a wheelchair can use to get into and out of the commercial vehicle without leaving the wheelchair, or a robot that is capable of lifting or piggybacking the user as would a human being.

The example in FIG. 1 shows one unmanned operation vehicle 2, one manned operation vehicle 3, one user terminal 4, one preceding user terminal 5, one assistant's terminal 6, and one piece of assistive equipment 7, but in practice, there is a plurality of the respective unmanned operation vehicles 2, the manned operation vehicles 3, and the assistive equipment 7, and there also is a plurality of users, preceding users, and assistants. Therefore, there is a plurality of the user terminals 4, the preceding user terminals 5, and the assistant's terminals 6 which respectively correspond to the number of users, preceding users, and assistants.

In addition, for convenience of explanation, the user and the preceding user may be described as different persons, and the user terminal 4 and the preceding user terminal 5 may be described as different objects; however, the user is the person who intends to use a commercial vehicle, and the preceding user is the person who is currently using a commercial vehicle or who has already reserved a commercial vehicle. Therefore, when the user reserves or uses a commercial vehicle, the user becomes the preceding user, and when the preceding user ends his or her use of a commercial vehicle, he or she returns to the status of user.

The server 1 is an information processing device comprising a communication unit 11, an information management unit 12, a commercial vehicle management unit 13, and an assistive work management unit 14. The server 1 is composed of a computer provided with hardware and software, and is composed of ROM (Read-Only Memory) in which a program is stored, a CPU (Central Processing Unit) that executes the program stored in the ROM, and RAM (Random-Access Memory) that functions as an accessible storage device. In terms of the operating circuit, an MPU (Micro Processing Unit), a DSP (Digital Signal Processor), an ASIC (Application Specific Integrated Circuit), an FPGA (Field Programmable Gate Array), etc., may be used in place of, or in addition to, the CPU (Central Processing Unit). And the communication unit 11, the information management unit 12, the commercial vehicle management unit 13, and the assistive work management unit 14 realize each of the functions described further below by means of software established in ROM.

The communication unit 11 provides information communication with the unmanned operation vehicle 2, the manned operation vehicle 3, the user terminal 4, the preceding user terminal 5, and the assistant's terminal 6 via a prescribed wireless telecommunication network, such as the Internet. The communication unit 11 uses a user information acquisition unit 111 to acquire the user's registration information, user ID's, external appearance characteristics, assistive work request information, carpooling request information, information regarding whether the user allows an on-board assistant, and the like. In addition, a vehicle operation information acquisition unit 112 acquires the current location of each commercial vehicle, reservation status, remaining fuel-charge information, driver information of each vehicle in the case of the manned operation vehicle 3, information regarding the presence/absence of the preceding users who are currently using each commercial vehicle and information relating to the preceding users themselves, which are managed by the server 1. A carpooling consultation result receiving unit 113 receives information regarding whether a preceding user accepts or refuses to carpool with other users who will board later, as well as his or her acceptance or refusal to carry out assistive work for other users who will board the vehicle when an inquiry is made regarding assistive work for fellow passengers.

The user information acquisition unit 111 further includes assistive work request acquisition unit 1111, a carpooling request information acquisition unit 1112, and an assistant ride-share possibility information acquisition unit 1113. The server 1 acquires by means of the assistive work request acquisition unit 1111 assistive work request information from the user terminal 4 regarding whether an assistive work service is needed as a condition for dispatching the vehicle that the user desires, via a prescribed wireless telecommunication network. In addition, the server 1, by means of the carpooling request information acquisition unit 1112, acquires carpool request information regarding whether a vehicle capable of carpooling is desired. Further, when the user requests assistive work service, the server 1 acquires by means of the assistant ride-share possibility information acquisition unit 1113 assistant ride-share possibility information regarding whether an assistant is permitted to share the ride after the assistant has provided assistive work at the time of boarding.

The vehicle operation information acquisition unit 112 further includes a remaining fuel-charge amount information acquisition unit 1121, a driver information acquisition unit 1122, and a preceding user information acquisition unit 1123. The server 1 acquires information using the remaining fuel-charge amount information acquisition unit 1121 from each commercial vehicle regarding the fuel currently remaining in each vehicle or the remaining charge in electrically driven vehicles. In addition, when the commercial vehicle is the manned operation vehicle 3, the server 1 acquires via the driver information acquisition unit 1122 the dedicated driver's gender, driving history, languages spoken, age, etc., from a vehicle operation information database 122DB, described further below. Moreover, the server 1 acquires information, in regard to age, gender, languages spoken, etc., which is related to a preceding user who is already riding or has already reserved a commercial vehicle, from a user information database 123DB, described further below.

The carpooling consultation result reception unit 113 further includes a fellow passenger assistive work consultation result reception unit 1131. The server 1 uses the fellow passenger assistive work consultation result reception unit 1131 to receive the result regarding whether a preceding user, who is to be joined by a fellow passenger, accepts or refuses to assist other users who wish to join the carpool in place of an assistant or assistive equipment.

The information management unit 12 stores information relating to users who are authorized to use the commercial vehicle operation system, and information relating to the plurality of the unmanned operation vehicles 2, the manned operation vehicles 3, assistants, and the assistive equipment 7, which are managed by the server. As described further below, since each commercial vehicle is equipped with an on-board control device, the information management unit 12 stores the user's boarding/deboarding locations and the respective current locations of the unmanned operation vehicle 2 and the manned operation vehicle 3 transmitted from the on-board control devices, based on a map information database 121DB managed by a map information management unit 121. In addition, use request information regarding when the vehicle is to be used, where it is to be used, what type of vehicle is to be used, and the destination, information relating to each of the commercial vehicles being managed, information relating to the drivers of the manned operation vehicles 3, and information regarding assistants and assistive equipment 7 are recorded by a vehicle operation information management unit 122 and stored in a vehicle operation information database 122DB. Moreover, the information management unit 12, by means of a user information management unit 123, stores identification information of the user terminal 4 possessed by the user, identification information for identifying the user, image information (such as a facial image) representing the external appearance characteristics of the user, and information such as gender, age, and languages spoken, so that fellow passengers can know with what type of people they are carpooling, as information relating to the user. The information relating to the user is stored in the user information database 123DB as user information history.

The commercial vehicle management unit 13 manages the vehicle desired by a user accessing the server 1 via the user terminal 4, and extracts and manages a plurality of vehicles that match user criteria by means of a candidate vehicle extraction unit 131 as candidate vehicles.

The method of selecting the candidate vehicles is based on the current locations of the unmanned operation vehicles 2 and the manned operation vehicles 3. In addition, the candidate vehicle extraction unit 131 includes an assistive work request selection notification unit 1311 and a carpooling request selection notification unit 1312, and urges the user to choose whether he or she wishes to make requests for assistive work service, such as during boarding and deboarding, and for carpooling. If the user desires assistive work, the candidate vehicle extraction unit 131 selects as candidate vehicles commercial vehicles that have assistants or assistive equipment 7. In addition, if the user desires the dispatching of a commercial vehicle in which there is a preceding user, i.e., desires carpooling, the candidate vehicle extraction unit 131 selects commercial vehicles that are suitable to the user for carpooling, in consideration of the current locations of the candidate vehicles, the number of people that can board the vehicles, and the like. In addition, by adding a function for further inputting personal information of the user, such as gender and age as input information sent from each of the user terminals 4 to the server 1, the candidate vehicle extraction unit 131 can seek and select commercial vehicles that have a preceding user suitable for carpooling and are capable of carpooling, based on the attributes of the person.

Moreover, if the user desires a carpooling vehicle, a carpooling consultation notification unit 135 consults with the preceding user terminal 5 of the preceding user, who is already on board the commercial vehicle desired by the user, or who has already reserved the commercial vehicle for boarding before the user, if the preceding user consents to carpooling. The usage fee for the preceding user and the estimated destination arrival time in the case that carpooling is carried out, calculated by means of a preceding user estimated destination arrival time calculation unit 1351 and a preceding user usage fee recalculation unit 1352, are reported to the preceding user terminal 5 of the preceding user together with the foregoing information,

The server 1 uses a vehicle selection notification unit 132 to issue a notification to the user terminal 4 prompting a selection of which vehicle, from among the candidate vehicles extracted by the candidate vehicle selection unit 131, is desired to be dispatched. In addition, when the vehicle selection notification unit 132 issues the notification to select the candidate vehicles, in the case that the user desires assistive work and there is an assistant dispatched by the system, a driver that also serves as an assistant in the case of the manned operation vehicle 3, or, in the case that a preceding user has accepted assistive work at the time of carpooling, described further below, assistant information is also notified to the user. The assistant information includes information, such as gender, age, and languages spoken, relating to each of the preceding users or assistants. The vehicle selection notification unit 132 can thereby provide information to the user so that the user can enjoy a vehicle dispatch and assistive service that better match the user's preferences.

In addition, the server 1 uses a dispatch/route determination unit 133 to determine a route from the current location of the vehicle for which the user desired dispatching to the user's boarding location, and a route from the user's boarding location to the user's destination. Then, the server 1 uses a dispatch command output unit 134 to output a command to move to the user's boarding location and destination to the dispatch vehicle. When the dispatch route and the route to the destination are computed, the user's current location may be used as the base point.

The server 1 uses an estimated boarding location arrival time calculation unit 136 to calculate the time it would take for a commercial vehicle managed by the system to arrive at the boarding location of the user requesting use. Further, the server 1 uses an estimated destination arrival time calculation unit 137 to calculate the time it would take for each commercial vehicle to arrive at the destination via the user's boarding location. Moreover, the server 1 uses a usage fee calculation unit 138 to calculate the usage fee required to arrive at the destination.

The assistive work management unit 14 manages assistive work, such as boarding and deboarding and the loading and unloading of luggage, as desired by the user accessing the server 1 via the user terminal 4. The assistive work management unit 14 has an assistive work command output unit 141, an assistant/assistive equipment assignment command output unit 142, and a fellow passenger assistive work consultation notification unit 143.

The server 1 uses the assistive work command output unit 141 to output a command to provide assistive work to the user scheduled to board and desiring assistive work to the communication unit of each commercial vehicle, the assistant's terminal 6 possessed by the assistant on board each commercial vehicle, or the preceding user terminal 5 possessed by a preceding user who consented to the assistive work. In the case of the manned operation vehicle 3, a notification of an assistive work command may be sent from the server 1 to a communication unit 31 of the manned operation vehicle 3, so that the dedicated driver of the manned operation vehicle 3 receiving the notification can issue an instruction to the assistant who is on board. Further, the driver may operate the assistive equipment 7 that is on board to execute the assistive work, or the driver himself or herself may also serve as an assistant to carry out the assistive work. In addition, if the assistive equipment 7 is capable of independently performing assistive work, such as that performed by a work robot and is provided with a communication unit that can communicate with the server 1, the assistive equipment may directly receive an assistive work command from the server 1 via a wireless telecommunication network in order to provide assistive service to the user.

Further, it was defined above that the assistant is on board the commercial vehicle; however, by means of the assistant/assistive equipment assignment command output unit 142, the server 1 may instruct the commercial vehicles and the assistant's terminals 6 to pick up assistants in order to provide assistive work to the users. In this case, the commercial vehicle picks up an assistant who appears directly at the user's boarding location or at the deboarding location of the destination, separately from the dispatched vehicle, or picks up an assistant in the middle of the route over which the scheduled dispatch vehicle travels to the user's boarding location or to the destination. There are various cases in which the assistant is picked up, such as on a road en route, at a standby station where the assistant stands by together with the commercial vehicle, in the vicinity of the assistant's home, and the like. In addition, the assistive equipment 7 need not be installed in the commercial vehicle, but may be mounted on the target commercial vehicle on a road in the middle of the route before the user board/deboards, or at a warehouse where the assistive equipment 7 is managed. It can be assumed that the driver of the manned operation vehicle 3, or a worker who manages the warehouse carries out the mounting.

If there is a preceding user who is on board, or is about to board, the commercial vehicle that could be a dispatch candidate, the server 1 uses the fellow passenger assistive work consultation notification unit 143 to consult with each preceding user terminal 5 of a preceding user who is on board a commercial vehicle, regarding whether the preceding user can provide assistive work to a user who may carpool with him or her. If the preceding user consents to the assistive work, the server 1 uses the candidate vehicle extraction unit 131 to extract the commercial vehicle in which the preceding user is boarded as a candidate vehicle to be dispatched to the user desiring the assistive work and carpooling.

In addition, when a notification is sent to a fellow passenger of assistive work consultation, the server 1 uses a fellow passenger assistive work compensation calculation unit 1431 to calculate the monetary amount corresponding to the compensation in the case that the preceding user carries out assistive work. For example, the fellow passenger assistive work compensation calculation unit 1431 calculates the reduction in charge of the usage fee for the commercial vehicle operation system of the preceding user currently being presented, or the reduction in charge of a discount coupon with which the fee for using the system the next or a subsequent time can be discounted. The server 1 then presents perk information to the preceding user's terminal 5, so that the preceding user is incentivized to proactively consent to the assistive work for the user desiring carpooling.

The unmanned operation vehicle 2 has an autonomous driving control unit 24 that is driven unmanned and autonomously along a route for which a notification has been sent by the server 1. The commercial vehicle operation system according to the present embodiment assumes that a mixture of a plurality of various commercial vehicles of different vehicle type and performance are used. Specific examples include vehicle types such as electric vehicles that run on the electric power of an on-board battery (a secondary battery or a fuel cell) or vehicles that use an internal combustion engine for power generation, vehicles that run by means of an internal combustion engine that uses gasoline, light oil, or hydrogen as fuel, hybrid vehicles, vehicles equipped with an automatic transmission, vehicles equipped with a manual transmission, compact/mid-sized/large vehicles, minivans, sedans, etc. In addition, vehicles of different performance, such as the user being able to switch between autonomous driving and manual driving, may also be included. Let us assume that information relating to vehicle types and performances as described above is registered in the server 1 in advance.

The unmanned operation vehicle 2 is provided with an on-board control device that has various control functions corresponding to the commercial vehicle operation system according to the present embodiment. The on-board control device includes a communication unit 21, a location detection unit 22, a usage status determination unit 23, an autonomous driving control unit 24, a person search unit 25, a user authentication unit 26, and an operation switching unit 27.

The unmanned operation vehicle 2 using the communication unit 21 carries out bidirectional information communication with the server 1 via a prescribed wireless telecommunication network, such as the Internet.

The unmanned operation vehicle 2 using the location detection unit 22 to detect the current location of the host vehicle using satellite positioning such as a GPS or an autonomous positioning function using a vehicle speed sensor, a gyro sensor, and an acceleration sensor, for example. The detected current location information is transmitted to the server 1 and used to ascertain the location of the unmanned operation vehicle 2. The detected current location information is also used for autonomous driving of a host vehicle.

The unmanned operation vehicle 2 uses the usage status determination unit 23 to determine whether a preceding user is on board the target vehicle. Specifically, it is determined whether a preceding user is using a host vehicle based on the detection result of a seating sensor that detects whether a person is seated in the passenger seat, a seat belt sensor that detects whether the seat belt is buckled, a camera provided in the vehicle, or the like.

The unmanned operation vehicle 2 uses the autonomous driving control unit 24 to automatically carry out all of the driving operations of acceleration, deceleration, and steering, and causes the host vehicle to travel along the route to the destination. Specifically, the unmanned operation vehicle 2 compares the current location of the host vehicle with the map information, in order to travel along the route to the destination. In addition, the unmanned operation vehicle 2 using on-board sensors, such as a radar and camera, ascertains various surrounding conditions, such as vehicular and pedestrian traffic, etc., the presence of traffic signals and signs, road shape signs, and obstacles, in order to determine the operations of acceleration, deceleration, and steering, required for safe travel. Then, various actuators relating to the acceleration/deceleration operation and the steering operation of the unmanned operation vehicle 2 are controlled in accordance with the determined operations.

When arriving near the user's boarding location, the unmanned operation vehicle 2 uses the person search unit 25 to search for the user based on the user's external appearance characteristics information registered in the user information database 123DB of the server 1. For example, a vehicle exterior camera is used to search for and identify the user based on the degree of matching between the faces, clothes, and external appearance characteristics of the people around the host vehicle and the registered user information. If the user to be identified is found, the unmanned operation vehicle 2 outputs a voice message to the user in the periphery of the host vehicle by means of a speaker, or displays a message by means of an electric display, to attract the user's attention to the host vehicle, and stops at a location where the user can board. Further, in the case of picking up an assistant in mid-route to a prescribed point, upon arrival to the vicinity of the boarding location, the unmanned operation vehicle 2 searches for and identifies the assistant based on the degree of matching between the information relating to the assistant, and the face, clothes, and external appearance characteristics of the assistant registered in the operation information database of the server 1, in the same manner as how the user is searched for in the vicinity of the boarding location. Further, in a process after finding the user and the assistant, each commercial vehicle may notify the user terminal 4 and the assistant's terminal 6 that that they have been found via the communication unit 11 of the server 1.

The unmanned operation vehicle 2 uses the user authentication unit 26 to determine whether the people identified by the person searching unit 25 are the correct user and correct assistant, to determine whether to allow the person to board. For example, a user ID allocated to each user by the user terminal 4 that is carried by the user is reported to the unmanned operation vehicle 2 via the communication unit of the server 1 in order to verify that the person identified by the person searching unit 25 is the user who made the dispatch reservation. Then, when the user has been verified as the correct user, the vehicle door is unlocked so that the user can board. Similarly, an assistant registration ID allocated to each assistant is used to authenticate whether the assistant is the assistant that should board.

The unmanned operation vehicle 2 uses the operation switching unit 27 to switch between a mode for carrying out autonomous driving to the destination in accordance with the user's intentions, and a mode in which the user drives the vehicle. Thus, after the user has boarded the unmanned operation vehicle 2, the user can choose whether to travel by means of autonomous driving to the destination or by means of the user's manual driving.

The manned operation vehicle 3 is a vehicle in which a dedicated driver drives the vehicle, and a vehicle in which there is no function related to autonomous driving, or a vehicle in which travel is carried out without using a function related to autonomous driving even if one exists in the unmanned operation vehicle 2. The communication unit 31, the position detection unit 32, and the usage status determination unit 33 are the same as those of the unmanned operation vehicle 2, so that the descriptions thereof are incorporated in the manned operation vehicle 3 according to the present embodiment. In addition, with regard to the person search unit and the user authentication unit in the manned operation vehicle 3, the dedicated driver himself or herself shall search for and authenticate specific users and assistants based on the situation around the host vehicle, the user information, and the operation information.

The user terminal 4 is an information communication terminal that is carried by the user who uses the unmanned operation vehicle 2 or the manned operation vehicle 3 of the commercial vehicle operation system, such as a smartphone, PDA, and mobile PC. The user terminal 4 includes a communication unit 41, a location detection unit 42, an information input unit 43, and an information display unit 44.

The communication unit 41 carries out bidirectional information communication with the server 1 via a prescribed wireless telecommunication network, such as the Internet. The location detection unit 42 uses satellite positioning such as GPS to measure the current location of the host terminal. The measured current location information is transmitted to the server 1 and is used for ascertaining the location of the user owning the user terminal 4 by the server 1.

The information input unit 43 is a user interface for the user to input information into the user terminal 4. The user uses the information input unit 43 to input various information necessary to use the unmanned operation vehicle 2 or the manned operation vehicle 3, and request information regarding whether the user desires assistive work and carpooling, and communicates the input information to the server 1 by means of the communication unit 41. The information display unit 44 displays vehicle information relating to commercial vehicles that can be used, user information such as the usage history and registration information of the commercial vehicle operation system of the individual user, on a display device such as a liquid-crystal display.

The preceding user terminal 5 is an information communication terminal that is carried by the preceding user who is on board, or who has already made a reservation to board and is about to board, the unmanned operation vehicle 2 or the manned operation vehicle 3 of the commercial vehicle operation system. As described above, the preceding user terminal 5 differs from the user terminal 4 only in that it is carried by the preceding user instead of the user, and includes a communication unit 51, a location detection unit 52, an information input unit 53, and an information display unit 54, in the same manner as the user terminal 4. The preceding user terminal 5 receives a carpooling consultation notification from the user terminal 4 via the communication unit 11 of the server 1, and the preceding user responds to the carpooling consultation notification by accepting or refusing. Moreover, with respect to an assistive work request, requested from the user terminal 4, the preceding user terminal 5 receives, via the communication unit 11 of the server 1, a consultation notification regarding whether the preceding user would be willing to carry out assistive work in place of an assistant or the assistive equipment 7 at the time of carpooling. The preceding user responds by accepting or refusing the work consultation.

The assistant's terminal 6 is an information communication terminal that is carried by a worker who provides assistive work, such as boarding/deboarding and the loading/unloading of luggage, for the user of the commercial vehicle operation system, and can be a smartphone, PDA, and mobile PC. The assistant's terminal 6 may be supplied by the business that provides the commercial vehicle operation system, or may be a personal information communication terminal possessed by each assistant. The assistant's terminal 6 includes a communication unit 61, a location detection unit 62, an information input unit 63, and an information display unit 64.

The communication unit 61 carries out bidirectional information communication with the server 1 via a prescribed wireless telecommunication network, such as the Internet. The location detection unit 62 uses satellite positioning such as GPS to measure the current location of the host terminal. The detected current location information is transmitted to the server 1 and is used for ascertaining the location of the assistant in possession of the assistant's terminal 6 by the server 1.

The information input unit 63 is a user interface for the assistant to input information into the assistant's terminal 6. The assistant uses the information input unit 63 to input information such as the date and time of day when the assistant is able to carry out assistive work, and the server 1 acquires the information input to the information input unit 63 via the communication unit 11 as vehicle operation information, in order to manage the assistive work schedule of the assistant. The information display unit 64 displays, on a display such as a liquid-crystal display, with respect to the assistant, the notification of an assistive work command, an instruction to board a commercial vehicle at a prescribed location, an instruction to deboard the vehicle after the assistive work, vehicle information relating to the commercial vehicle on which the assistant is instructed to board, user information regarding the user requesting assistive work, the assistant's assistive work schedule information, and the registration information of the assistant himself or herself.

The assistive equipment 7 includes power lifts, wheelchair lifts, passenger robots, or the like, which assist the user of the commercial vehicle operation system in getting in and getting out of the vehicle, in the loading and unloading of luggage, etc. Dedicated assistive equipment 7 may be permanently installed in the commercial vehicle. In addition, the assistive equipment 7 may be managed in the warehouse of a station, rather than being permanently installed, and then mounted on each commercial vehicle as deemed necessary.

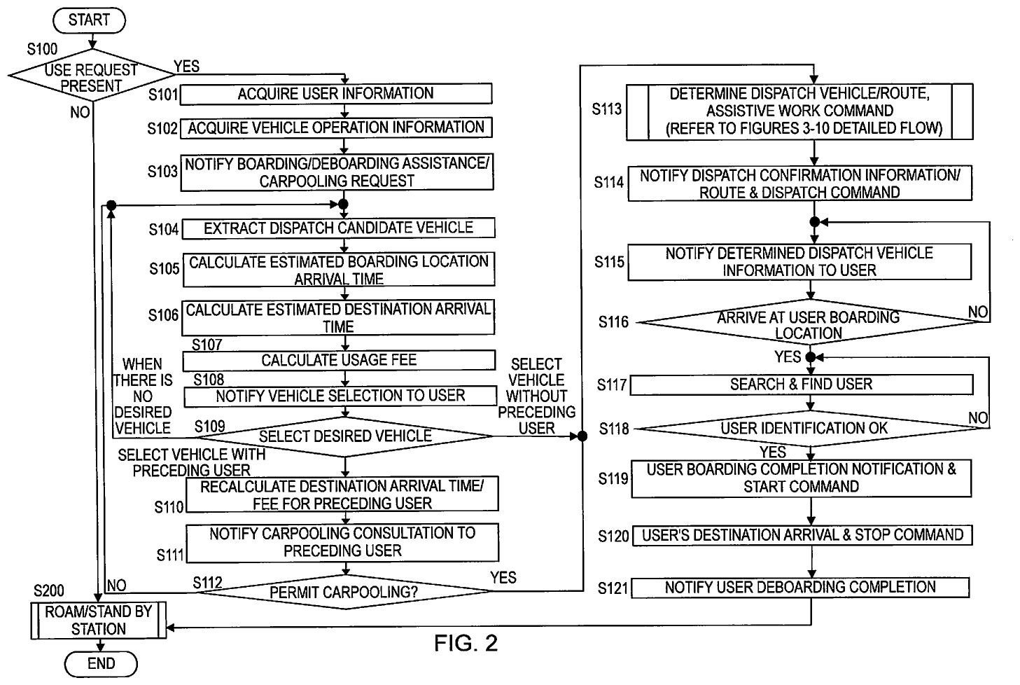

Next, the processing flow executed by each function provided in the server 1 will be described with reference to the flowchart of FIG. 2. The flowchart of FIG. 2 is repeatedly calculated at regular time intervals, for example, sampled every 10 [ms].

In Step S100, the server 1 receives a use request access from each of the user terminals 4 in FIG. 1. Examples of the use request access to be transmitted from the user terminal 4 include, in addition to the user's identification information and the user's location information, desired boarding location information, destination information, and candidate vehicle conditions, which are input by the user by operating the user terminal 4. Here, the server 1 cross-checks the user's identification information which is registered in advance and the identification information received from the user terminal 4 to determine which the particular user. If there is no use request from a user, in Step S200, the server 1 sends an instruction to the unmanned operation vehicle 2 or the manned operation vehicle 3 in FIG. 1 to roam or stand by at a station.

In Step S100, if a use request access is received from a particular user terminal 4, the process proceeds to Step S101, and the server 1 acquires the user information from the user terminal 4. The user information acquired here includes the user's location information, desired boarding location information, destination information, information on the number of passengers, and candidate vehicle conditions. The user's location information is information representing the current location of the user and is detected and transmitted by the location detection unit 42. The desired boarding location information is information representing the content of the desired boarding location. The desired boarding location information may be information representing a specific point, or information indicating a range, such as the surroundings of the user's current location. The destination information is information representing the destination to which the user moves by boarding the unmanned operation vehicle 2 or the manned operation vehicle 3. The candidate vehicle conditions are conditions for requesting the selection of vehicles that meet the user's criteria as candidate vehicles in advance, such as restricting the time at which it is desired that the commercial vehicle arrive at the desired boarding location, or limiting the gender of the driver to female, and the like. The desired boarding location information, destination information, information on the number of passengers, and candidate vehicle conditions are input and transmitted by the user himself or herself that operates the user terminal 4.

In Step S102, the server 1 acquires vehicle operation information from each of the unmanned operation vehicles 2 and each of the manned operation vehicles 3. The vehicle operation information acquired here includes location information, vehicle type information, preceding user information, and remaining fuel-charge information, relating to each commercial vehicle. The vehicle location information is information that represents the current location of each commercial vehicle. The vehicle type information is information such as the type of vehicle, such as a minivan, sedan, etc., as well as specific vehicle types/vehicle models. The preceding user information is information that represents whether a preceding user is on board, or has already made a reservation to board each commercial vehicle, as well as the number of users. The remaining fuel-charge information is information that represents the remaining fuel of each commercial vehicle, or the remaining charge of the electrically driven vehicle, and is used for ascertaining the travel range of each commercial vehicle. Moreover, in the case of the manned operation vehicle 3, gender information, driving history information, information on the languages spoken by the driver, of each driver is acquired as the driver information of each vehicle.

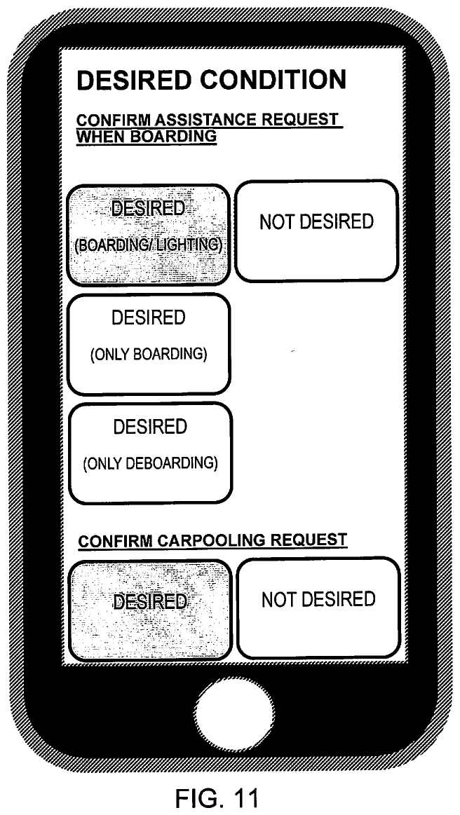

In Step S103, a notification regarding the user's selection of whether the user desires assistive work at the time of boarding/deboarding the commercial vehicle, as well as whether the user desires carpooling is sent to the user terminal 4. FIG. 11 shows one example of a notification that is displayed on the screen of the user terminal 4. FIG. 11 is an example showing the result of the user receiving a selection notification and selecting a desire for assistive work and for carpooling.

In Step S104, candidate vehicles to be presented to the user are extracted based on the user information acquired in Step S101, the vehicle operation information acquired in Step S102, and the information on the desire for carpooling as well as for assistive work at the time of boarding/deboarding acquired in Step S103. Specifically, from among candidate vehicles that are in the vicinity of the user's current location and in which it is possible to secure a seat for boarding by the user, and that can satisfy the user's respective desires regarding assistive work and carpooling at the time of boarding and deboarding, vehicles whose time to arrival at the user's desired boarding location from the current location of the unmanned operation vehicle 2 and manned operation vehicle 3 are short, are preferentially extracted. It may be configured such that the user can select from prioritizing in the order of the desired vehicle type, in the order in which the number of people capable of riding is greater than the number of people wishing to ride, in the order in which the usage fee is low, in the order in which the driver's driving history is long, or the like. In addition, the plurality of candidate vehicles that can be dispatched are preferably extracted from vehicles in which is secured the amount of remaining fuel or charge with which it is possible to move from the current location of the candidate vehicle, via the user's boarding location, to the user's destination, using the shortest route.

In Steps S105 and S106, the server 1 calculates, for each candidate vehicle, the boarding location arrival estimated travel time, which is the time it takes from the current locations of the plurality of extracted candidate vehicles to arrive at the user's desired boarding location, and the destination arrival estimated travel time, which is the time it takes to arrive at the destination via the user's desired boarding location. In the process of Steps S105 and S106, the server 1 can calculate each estimated arrival time based, not on the travel time, but on the current time.

In Step S107, the usage fee that is required when the user uses each of the plurality of extracted candidate vehicles and rides the vehicle from the desired boarding location to the destination is calculated.

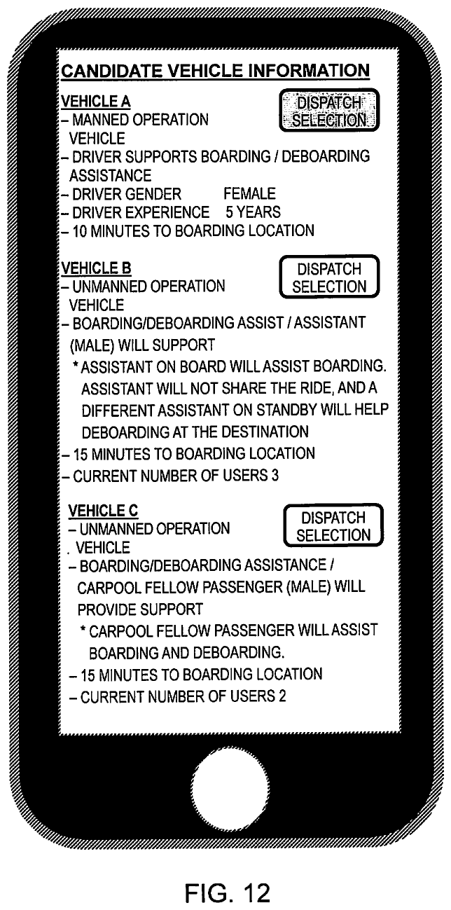

In Step S108, a notification of the extraction and calculation results of Step S103 to S107 is sent to the user terminal 4. FIG. 12 shows one example of a notification displayed n the screen of the user terminal 4. FIG. 12 is an example in which a user desires assistive work for boarding/deboarding, as well as carpooling, and the corresponding candidate vehicle information is notified. In addition to information regarding whether the vehicle is the unmanned driving vehicle 2 or the manned driving vehicle 3, since the user desires assistance both when boarding and deboarding, information on who will provide assistance at the time of boarding/deboarding, and whether an assistant will also be on board during transport, is reported. In addition, FIG. 12 is an example in which the travel time to the user's boarding location, the travel time to the destination via the user's boarding location, the usage fee to the destination, the driver information in the case that the candidate vehicle is the manned operation vehicle 3, and the number of preceding users that are currently using, or that have already placed a use reservation for, the candidate vehicle are reported. By presenting detailed information, it becomes possible for the user to select the commercial vehicle that better suits the user's personal preferences. When there are numerous candidate vehicles that cannot be displayed on one screen, all of the candidate vehicles can be displayed by scrolling the screen of the user terminal 4.

The information calculated and displayed in each of the Steps S104 to S107 may be some of the items, rather than all of the items, shown in FIG. 12. By the reporting of at least information relating to the boarding/deboarding assistive service, the user is able to select a vehicle that can provide the desired assistive work at the time of boarding/deboarding, according to the user's own preferences or needs.

The user pushes a dispatch selection button for the desired vehicle using the user terminal, from among the plurality of candidate vehicles presented in Step S108, in order to notify the server 1 of the vehicle that is desired to be dispatched. FIG. 12 is a specific example of a case in which the user selected vehicle A to be dispatched, in which the selection is made to be recognizable by changing the background color of the dispatch selection button of the selected vehicle.

In Step S109, it is determined whether the user has selected a desired vehicle from the candidate vehicles presented in Step S108, and whether the selected desired vehicle is a vehicle that has or does not have a preceding user. If the user selected a commercial vehicle that does not have a preceding user, the server 1 determines, in Step S113 described further below, the dispatch vehicle and the route from the user's desired boarding location to the destination. If the user selected a commercial vehicle that has a preceding user, the server 1 process proceeds to Step S110, described further below. In addition, if the candidate vehicles notified in Step S108 do not include the user's desired vehicle, the extraction conditions of the candidate vehicles are changed, and the server 1 repeats the process from Step S104. For example, if one reason that the user does not pick a vehicle in Step S109 is that the time required for the commercial vehicle to arrive at the user's desired boarding location is too short, the server relaxes the conditions to include commercial vehicles for which the time required to arrive at the desired boarding location is longer in relation to the previous conditions.

In Step S110, how much delay would occur in the destination arrival time of the preceding user who is currently on board or who has already made a reservation to board, and how much of the fee would be discounted if carpooling is carried out, if detouring to the desired boarding location of a user who is planning to board, or to the destination of the user who is planning to board, are calculated. If the vehicle selected by the user in Step S109 is a commercial vehicle that has a preceding user, that is, in the case that the user selected a desired dispatch vehicle under the condition that it may be a carpool, in Step S111, described further below, the server 1 asks the preceding user whether he or she accepts or refuses the carpooling request. A case can be conceived of in which a problem occurs wherein the preceding user does not desire carpooling in the first place, or a case in which carpooling may be accepted but arrival time to the destination is delayed as a result of carpooling. Therefore, the server 1 recalculates the destination arrival time and usage fee of the preceding user when carpooling with the user, and presents the information to the preceding user at the time of the carpooling consultation notification, so that it becomes easier to decide whether to accept or refuse carpooling. The delay in the arrival time is calculated in accordance with the detoured route, and the discounted fee is calculated, for example, by stipulating that the fee for the route while the ride is shared is equally divided among the passengers.

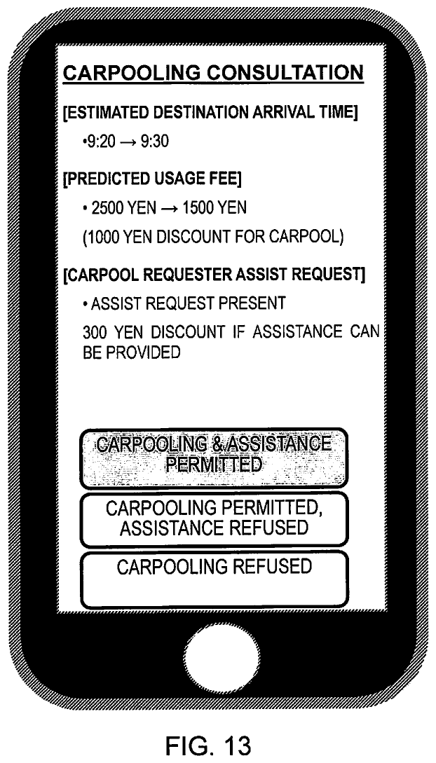

In Step S111, the preceding user terminal 5 belonging to the preceding user who is currently on board, or has already made a reservation to board, the commercial vehicle desired and selected by the current user to be dispatched, is notified of the calculation result of Step S110 as well as a carpooling consultation regarding whether a user can be added. FIG. 13 shows one example of a notification displayed on each of the preceding user terminals 5 of the preceding users who are currently on board, or have already made a reservation to board. The preceding user terminal 5 is also notified of information on the before and after change in the estimated destination arrival time for the preceding user, the before and after change in the usage fee for the preceding user, the fee that is discounted as a result of carpooling, and whether the user requesting the carpool desires assistance at the time of boarding/deboarding. Furthermore, in this example, the preceding user terminal 5 is sent a prompt to select whether to accept or refuse to carry out assistive work for the user with whom the ride is to be shared. FIG. 13 is one example of a result in which the preceding user accepts to provide assistive work, such as boarding/deboarding, to the user requesting the carpooling and assistive work. In the notification example shown in FIG. 13, in order to separate the results for the carpooling consultation and the provision of assistive work to the user, one option from among three options, an option in which both carpooling and assistive work are permitted, an option in which carpooling is permitted but assistive work is not, and an option in which carpooling itself is refused, can be selected by means of pushing a button.

In Step S112, it is determined whether all of the preceding users who are already using or have already placed use reservations for the vehicles chosen by the user for dispatch, have accepted or refused to carpool with the user. If all of the preceding users accepted carpooling, in Step S113, described further below, the server 1 determines the dispatch vehicle, and the route on which the determined dispatch vehicle travels to the user's desired boarding location and the destination. If any one of the preceding users refused to carpool, the server 1 changes the extraction conditions of the candidate vehicles, and repeats the process from Step S104. In this case, the extraction conditions may be expanded, or, simply, the previously extracted candidate vehicles, excluding only the refused vehicle, may be reported again to the user terminal 4 for selection.

In Step S113, the server 1 determines the commercial vehicle selected by the user as the dispatch vehicle. In addition, the server 1 determines a route for the determined commercial vehicle to start from the current location of the host vehicle, via the user's scheduled boarding location, and reach the user's destination. Further, if the user requests assistive work, the server 1 sends a notification of an assistive work command to the driver/assistant via the communication unit 31 in the case of the manned operation vehicle 3. In addition, the server 1 may send a notification of an assistive work command to the assistant's terminal 6 possessed by the specialized assistant. Further, in the case that the preceding user has consented to the assistive work, the server 1 sends a notification of an assistive work command to the preceding user terminal 5.

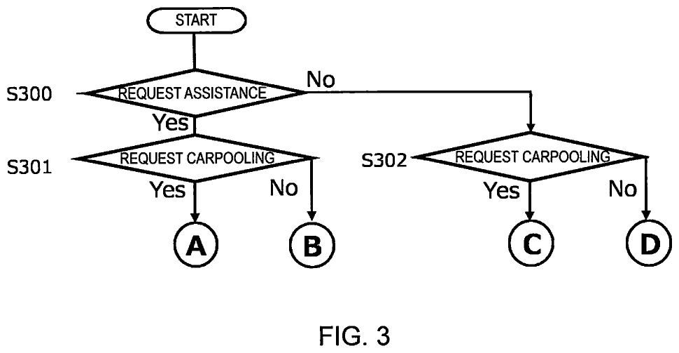

The process of determining the dispatch vehicle in Step S113 is shown in FIGS. 3 to 10.

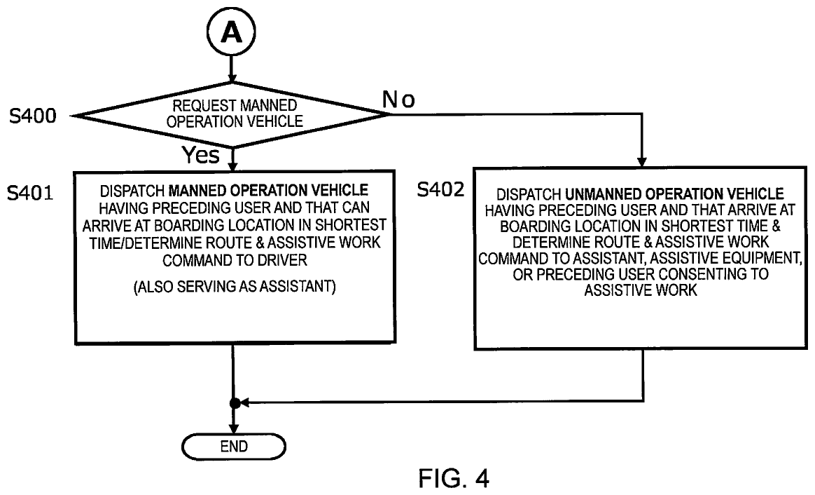

FIG. 3 is a flowchart for extracting candidate vehicles. In FIG. 3, the server 1 classifies the vehicles desired by the user in the process of Steps S300-S302 into four patterns of a combination of the presence/absence of an assistive work request, and the presence/absence of a carpooling request. When branching to A in FIG. 3, that is, a case in which assistive work is desired and carpooling is desired, the control by the server 1 proceeds to the process shown in FIG. 4.

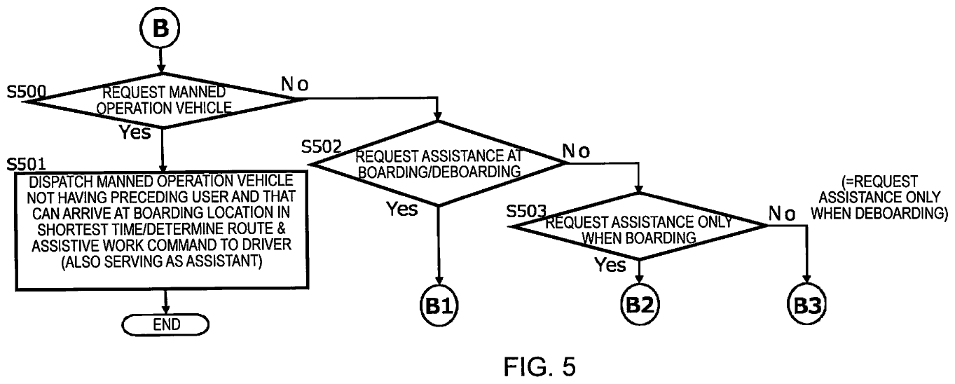

In FIG. 4, the server 1 determines whether the user desires a manned operation vehicle with a dedicated driver in Step S400. In the case that a vehicle with a dedicated driver is desired, in Step S401, the server 1 determines the manned operation vehicle 3 in which the preceding user is on board or has already made a reservation to board, and for which the arrival time until the boarding of the user is shortest as the dispatch vehicle, and calculates the route. In the case of the present embodiment, the vehicle is operated with the driver also serving as the assistant, but the assistive work may be provided by having an assistant other than the driver on board the manned operation vehicle 3, or by mounting the assistive equipment 7 in the vehicle. In addition, the vehicle may be operated by a preceding user who has consented to assist the user wishing to carpool and who takes the place of an assistant. In the case that the user does not desire the manned operation vehicle 3, in Step S402, the server 1 determines the unmanned operation vehicle 2 in which an assistant is riding or in which the assistive equipment 7 is mounted, and for which the time to arrive at the boarding location is shortest, as the dispatch vehicle and calculates the route. Further, the server 1 may determine the unmanned operation vehicle 2 in which a preceding user who has consented to assist the user wishing to carpool is currently on board or have already made a reservation to board, and for which the time to arrive at the boarding location is shortest, as the dispatch vehicle and calculates the route. In the present embodiment, cases in which the user desires assistive work at the time of boarding and/or at the time of deboarding are described in the following examples and FIGS. 5-8.

Returning to FIG. 3, when branching to B in FIG. 3, that is, a case in which the user desires assistive work but does not desire carpooling, the process proceeds to the process shown in FIG. 5.

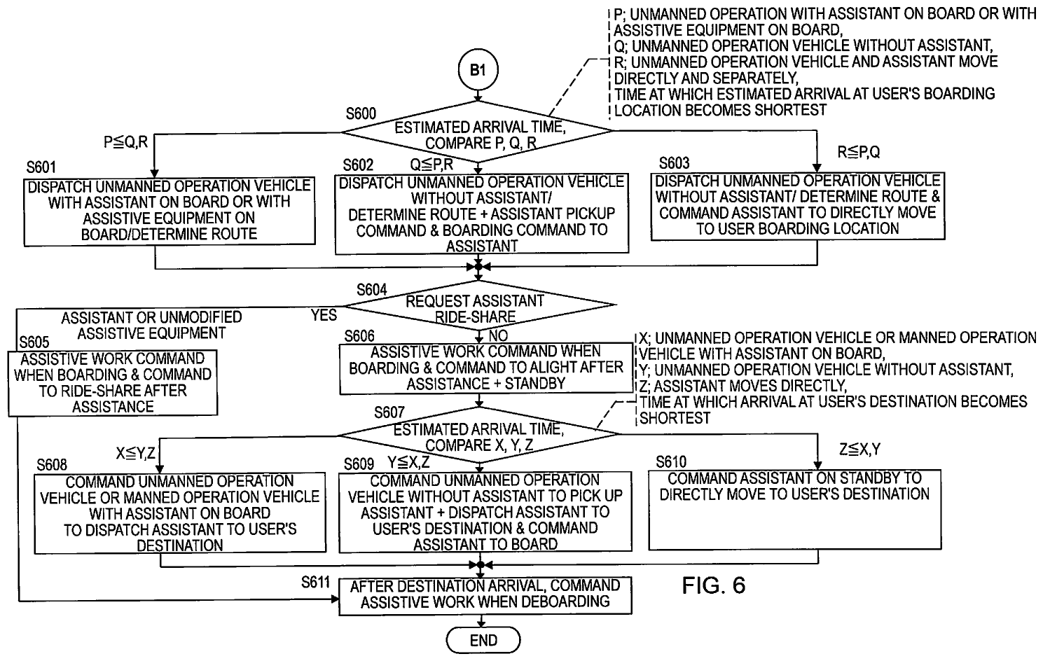

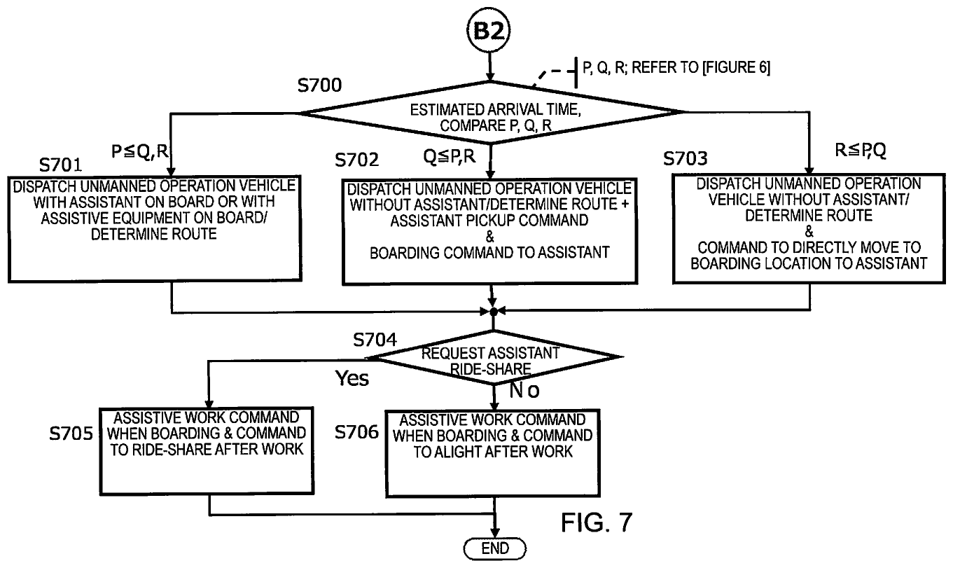

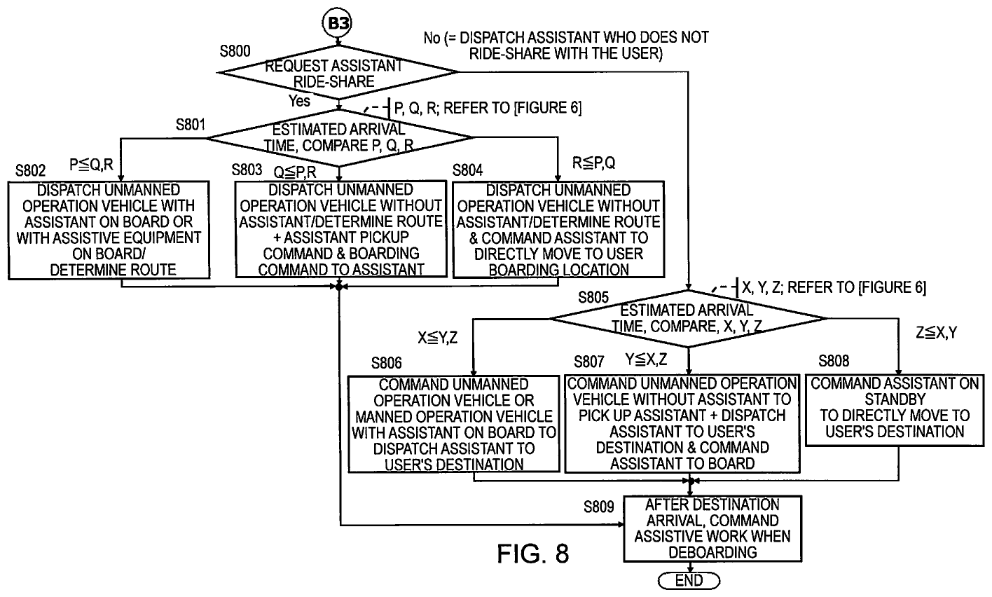

In FIG. 5, the server 1 determines whether the user desires a manned operation vehicle 3 with a dedicated driver in Step S500. In the case that the user desires the manned operation vehicle 3, in Step S501, the server 1 determines the manned operation vehicle 3 that does not have a preceding user and for which the time to arrive at the user's boarding location is shortest, as the dispatch vehicle and calculates the route. The process in Step S401 of FIG. 4 is invoked as the process for the assistant or the assistive equipment that carries out the assistive work. If the user does not desire the manned operation vehicle 3, in Step S502, the server 1 determines whether assistive work is required both when boarding and deboarding. If the user desires the dispatching of the unmanned operation vehicle 2 and desires assistance both when boarding and deboarding, the control by the server 1 proceeds to the process shown in FIG. 6 via the branch to B1. If the user desires the dispatching of the unmanned operation vehicle 2 and desires assistance either when boarding or deboarding, the control by the server 1 proceeds to the branch to B2 or B3 in Step S503. That is, if the user desires assistance only when boarding, the control by the server 1 proceeds to the process shown in FIG. 7 via the branch to B2. If the user desires assistance only when deboarding, the control by the server 1 proceeds to the process shown in FIG. 8 via the branch to B3.

In FIG. 6, the server 1 calculates and compares the estimated arrival times P, Q, R in Step S600. The estimated arrival time P is the shortest period of time estimated for the unmanned operation vehicle 2, without a preceding user but with an assistant on board, to arrive at the user's boarding location from the current location. The estimated arrival time Q is the shortest period of time estimated for the unmanned operation vehicle 2, without a preceding user without an assistant on board, to arrive at the user's boarding location after picking up an assistant waiting at a standby station or on the road on the way to the user desiring assistive work. The estimated arrival time R is the shortest period of time estimated for the unmanned operation vehicle 2, without a preceding user and without an assistant on board, to take to head to the user's boarding location separately from the assistant who is on standby, and thereafter join with the user and the assistant at the user's boarding location. When the estimated arrival time P is the shortest time, in Step S601 the server 1 determines an unmanned operation vehicle 2 which does not have a preceding user but does have an assistant on board as the dispatch vehicle, and calculates a route to the destination via the user's boarding location. When the estimated arrival time Q is the shortest, in Step S602, the server 1 determines the unmanned operation vehicle 2, which does not have a preceding user and does not have an assistant or assistive equipment on board as the dispatch vehicle, and calculates a route to the destination via the user's boarding location after picking up an assistant on standby. Then, the server 1 outputs a command to the vehicle to pick up the target assistant at a prescribed location, and sends a notification to the assistant's terminal 6 of the assistant who is on standby to board the vehicle at the prescribed location. When the estimated arrival time R is the shortest time, in Step S603, the server 1 determines the unmanned operation vehicle 2, which does not have a preceding user and does not have an assistant on board, as the dispatch vehicle and calculates a route to the destination via the user's boarding location. In addition, the server 1 sends a notification to the assistant's terminal 6 of the assistant on standby of a command to carry out assistive work to the user, and a command to directly move to the user's boarding location.

Next, in Step S604, the server 1 determines whether the user wishes the assistant to ride with the user to the destination. In the case that the user wishes the assistant to ride with the user, in Step S605, the server 1 sends a notification to the assistive equipment 7 or the assistant's terminal 6 of the assistant in Steps S601 to S603 of a command to carry out assistive work when the user boards, and, for the assistant to also ride the commercial vehicle and head to the destination after the work. In the case that the user does not wish the assistant to ride with the user, in Step S606, the server 1 sends a notification to the assistant's terminal 6 of the assistant in Steps S601 to S603 of a command to carry out assistive work when the user boards, and, for the assistant to deboard after the assistive work and to stand by in the surrounding area until the next assistive work command. If the assistant does not ride with the user to the destination, an assistant to assist at the time of deboarding must be sent anew to the destination, so that the control by the server 1 proceeds to the process after Step S607.

In Step S607, the server 1 calculates and compares the estimated arrival times X, Y, Z. The estimated arrival time X is the shortest period of time estimated for the unmanned operation vehicle 2 or the manned operation vehicle 3, without a preceding user but with an assistant on board, to arrive at the user's destination from the current location. The estimated arrival time Y is the shortest period of time estimated for the unmanned operation vehicle 2, without a preceding user and without an assistant on board, to arrive at the user's destination after picking up an assistant waiting at a standby station or on the road on the way to the user's boarding location for the next system user. When an assistant waiting near the user's destination moves to the destination separately from the commercial vehicle in which the user rides and joins the vehicle used by the user at the destination, the estimated arrival time Z is the shortest period of time estimated for said vehicle to arrive at the user's destination from the current location. In the case that the estimated arrival time X is the shortest, in Step S608, the server 1 issues a command to the commercial vehicle, without a user or a reserved user and with an assistant on board, to dispatch the assistant to carry out assistive work when the user deboards at the destination. In Step S608, in the case that the vehicle to which the assistant is dispatched is the manned operation vehicle 3, the driver may also serve as the assistant, instead of a specialized assistant. In the case that the estimated arrival time Y is the shortest, in Step S609, the server 1 issues a command to the target unmanned operation vehicle 2 to pick up an assistant on standby and to dispatch the assistant to the user's destination, and issues a command to the assistant's terminal 6 of the target assistant to board said vehicle. In the case that the estimated arrival time Z is the shortest, in Step S610, the server 1 issues a command to the assistant's terminal 6 of the target assistant to move directly to the user's destination.

In Step S611, the server sends a notification to the assistant's terminal 6 of the assistant of Steps S605 and S608-S610 of a command to carry out assistive work at the time of deboarding. In addition, the server 1 can send a notification the user himself or herself to use the assistive equipment 7. Further, if the assistive equipment 7 is a robot that can receive a command from the server 1, the assistive equipment 7 can start the assistive work as soon as the notification is received.

FIG. 7 is a process when the user desires assistance only when boarding. This process is obtained by excluding the process relating to assistance at the time of deboarding from the process shown in FIG. 6. Steps S600-S606 of FIG. 6 are invoked by the processes in Steps S700-S706. The reason for confirming with the user who does not desire carpooling and who requests assistive work only when boarding whether the user wishes the assistant to ride with the user in the unmanned operation vehicle 2, which is the dispatch vehicle, is that it can be assumed that the user wishes the assistant to ride with the user for safety in the case of an unforeseen situation before arriving at the destination. In addition, it is also assumed that the user may wish the assistant to ride with him or her because they are in need of someone to talk to until arrival at the destination.

FIG. 8 is a process when the user desires assistance only during deboarding. First, in Step S800, the server 1 determines whether the user wishes the assistant to ride with the user while en route to the destination. That is, a case may be assumed in which, if a family member assists the user when boarding, the user would not desire an assistant to ride with the user, and wishes there to be an assistant only at the deboarding location.

In Step S800, in the case that the user wishes an assistant to ride with the user, the control by the server 1 proceeds to the process of Steps S801-S804. Steps S600-S603 of FIG. 6 are invoked for the process of Steps S801-S804. In Step S800, in the case that the user does not wish the assistant to ride with the user to the destination, it is necessary to dispatch an assistant to carry out assistive work at the time of deboarding, so that the control by the server 1 proceeds to the process after Step S805. Steps S607-S611 of FIG. 6 are invoked for the process of Steps S805-S809.

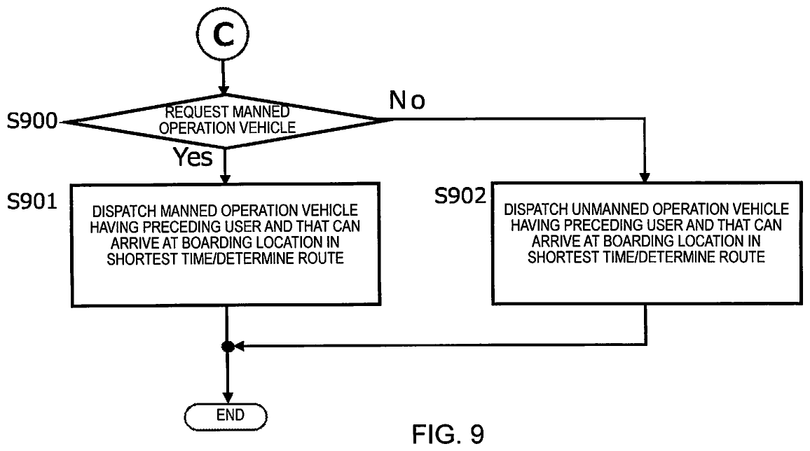

Returning to FIG. 3, when branching to C in FIG. 3, that is, a case in which the user does not desire assistive work both when boarding and deboarding but does desire carpooling, the control by the server 1 proceeds to the process shown in FIG. 9. In FIG. 9, the server 1 determines whether the user desires the dispatching of the manned operation vehicle 3 in Step S900. In the case that the user desires the manned operation vehicle 3, in Step S901, the server 1 determines the manned operation vehicle 3 that has a preceding user and for which the time to arrive at the user's boarding location is shortest, as the dispatch vehicle and calculates the route. In the case that the user does not desire the manned operation vehicle 3, in Step S902, the server 1 determines the unmanned operation vehicle 2 that has a preceding user and for which the time to arrive at the boarding location is shortest, as the dispatch vehicle and calculates the route.

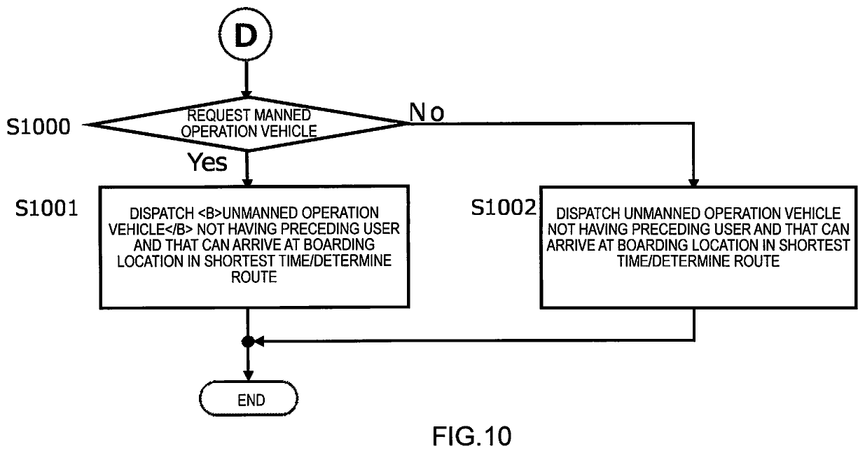

Returning to FIG. 3, when branching to D in FIG. 3, that is, a case in which the user does not desire assistance during boarding/deboarding and also does not desire carpooling, the control by the server 1 proceeds to the process shown in FIG. 10. In FIG. 10, the server 1 determines whether the user desires the manned operation vehicle 3 in Step S1000. In the case that the user desires the manned operation vehicle 3, in Step S1001, the server 1 determines the manned operation vehicle 3 that does not have a preceding user and for which the time to arrive at the user's boarding location is shortest, as the dispatch vehicle and calculates the route. In the case that the user does not desire the manned operation vehicle 3, in Step S902, the server 1 determines the unmanned operation vehicle 2 that does not have a preceding user and for which the time to arrive at the user's boarding location is shortest, as the dispatch vehicle and calculates the route.

In Step S114, the server 1 transmits, to the unmanned operation vehicle 2 or the maimed operation vehicle 3 corresponding to the vehicle to be dispatched, dispatch confirmation information indicating that the vehicle has been selected as the dispatch vehicle, and the route information determined in Step S113, and outputs an instruction for the vehicle to be dispatched to the user's desired boarding location. In the case that the determined commercial vehicle is the unmanned operation vehicle 2, after the notification is received, autonomous driving is started in the direction of the planned boarding location. In the case that the determined commercial vehicle is the manned operation vehicle 3, after the notification is received, the route information is input to the on-board navigation device, and the driver begins to drive the host vehicle in the direction of the planned boarding location.

In Step S115, the server 1 sends a notification to the user terminal 4 of dispatch confirmation information representing information regarding the determined vehicle to be dispatched, and current location information of the confirmed dispatch vehicle.

In Step S116, the server 1 determines whether the dispatch vehicle has arrived at the user's desired boarding location based on the vehicle location information. If it has not reached the boarding location, the control by the server 1 returns to Step S115, and the current location information of the dispatch vehicle is sequentially transmitted to the user terminal 4, in order to notify the user that the dispatch vehicle is indeed on its way. When the dispatch vehicle reaches the vicinity of the boarding location, a search for the user is initiated in Step S117.

In Step S117, if the dispatch vehicle is the manned operation vehicle 3 with a dedicated driver, the dedicated driver seeks the user visually based on the identification information relating to the user received in Step S100. In contrast, if the dispatch vehicle is the unmanned operation vehicle 2, sensors such as a radar and a camera search for a person matching the external appearance characteristics of the user in the surrounding environment based on identification information related to the user received in step S100. Process control repeats Step S117 until the user is found, and the search is terminated. If the user was able to be identified, the dispatch vehicle outputs a voice message to the user in the periphery of the host vehicle by means of a speaker, or displays a message by means of an electronic display. Alternatively, the communication units 21, 31 send a notification to the user terminal 4 via the wireless telecommunication network by means of the server 1 that the host vehicle has arrived at the boarding location. Thus, the dispatch vehicle issues an alert for the user to the host vehicle and stops at a location where the user can board.

In Step S118, it is verified that the person found is the user who requested the vehicle dispatch. Specifically, notification of the user ID assigned to each user from the user terminal 4 possessed by the user is sent to the dedicated driver of the unmanned operation vehicle 2 or the manned operation vehicle 3 via the communication unit 11 of the server 1, in order to cross-check the user ID assigned to the specific user. If the user is verified to be the legitimate user by cross-checking the user ID, the vehicle door of the unmanned operation vehicle 2 or the manned operation vehicle 3 is unlocked for the user to board the vehicle. If there is no verification match, process control returns to Step S117 and again searches for the legitimate user in the surroundings. Alternatively, a user ID verification request may be issued again to the person specified earlier.

In the process of Steps S117 and S118, there may be cases in which only the user makes the dispatch reservation, and the person who actually boards the vehicle may be another person, such as a friend or family member of the user. In that case, when a usage request is made, the user sends a notification to the server 1 and registers the user registration information including the user ID and the external appearance characteristics of the person who actually boards the vehicle, in order to make it possible to search for and to verify the person who actually boards the vehicle. Alternatively, the user ID information of the user who requested the use may be transmitted to the terminal possessed by the person who actually boards the vehicle so that the actual user can temporarily carry out the verification work and board the vehicle.

In Step S119, the server 1 confirms that the user has boarded and outputs a start command to the commercial vehicle. In the case of the manned operation vehicle 3, a notification of the result of confirmation by the driver is sent to the server 1. In the case of the unmanned operation vehicle 2, boarding is confirmed by a seating sensor mounted in the vehicle, or the user terminal 4 sends a notification to the server 1 that boarding has been completed in order to confirm boarding. When it is confirmed that the user has boarded, the server 1 issues a command to start the target commercial vehicle.

In Step S120, the server 1 determines whether the dispatched vehicle has arrived at the user's destination based on the vehicle location information. If the vehicle has arrived at the destination, the server 1 outputs a command to the commercial vehicle to stop the vehicle at a place where the user can get off, and prompts the user to deboard.

In Step S121, the server 1 confirms the deboarding of the user. For example, the user operates the user terminal 4 to notify the server 1 that the deboarding has been completed. When it is confirmed that the user has deboarded, the server 1 sends a notification to the user of the final usage fee.

In Step S200, the server 1 sends an instruction to each commercial vehicle to either roam about on the surrounding roads until the next use request, or to stand by at a defined parking lot or a station that is exclusively managed by the system.

As described above, by means of the commercial vehicle operation system of the present embodiment, the following effects can be achieved.

In the commercial vehicle operation system according to the present embodiment, whether the user requires assistive work at the time of boarding/deboarding the dispatch vehicle is reported to the server managed by the system; as a result, a vehicle that can provide assistive work service to the user is dispatched. As a result, the degree of satisfaction with the system can be increased, and the commercial vehicle is dispatched to the right person in the right place based on the necessity of assistive work, so that wasteful energy consumption can be suppressed.

In addition, in the commercial vehicle operation system of the present embodiment, information relating to the current location of each commercial vehicle, current usage status, and the availability of assistive work is acquired; as a result, dispatch candidate vehicles that are capable of providing the service required by the user can be presented to the user in advance, so that the user can select the vehicle that best meets the user's needs. Thus, it exhibits the effect that the level of satisfaction of the service provided to the user can be further increased.

Moreover, in the commercial vehicle operation system of the present embodiment, since the user can confirm the necessity of the assistive work at the time of boarding/deboarding, it is possible to extract only those vehicles as candidate vehicles that can provide the assistive service at the time requested by the user. Therefore, it is not necessary to present extra vehicle information that the user does not need, so that selection becomes easy for the user when selecting the dispatch vehicle. In addition, the user can not only request a vehicle capable of carrying out assistive work both when boarding/deboarding, but can also request assistive work either at the time of boarding or deboarding. Therefore, since there are more options of candidate vehicles for the user, the possibility of providing the service of this system and the operating rate of the commercial vehicle itself are improved.

Further, in the commercial vehicle operation system of the present embodiment, since it is possible to confirm whether the user wishes to ride in a carpool vehicle, the user can select the desired vehicle in a more detailed manner, and it is possible to select only those vehicles as candidate vehicles that can provide the carpooling service requested by the user. As a result, it is not necessary to present extra vehicle information that the user does not need, and the user can easily determine the selection of the vehicle to be dispatched.

In addition, in the commercial vehicle operation system of the present embodiment, when a vehicle that has a preceding user that is currently on board or has already made a reservation to board is selected as the desired carpool vehicle to be dispatched, the preceding user is issued a consultation notification regarding whether to accept or refuse carpooling. As a result, the disadvantage that the preceding user cannot arrive at the destination within the desired time can be avoided, and it is possible to provide a carpool vehicle to the user after confirming the intentions of the preceding user.

Further, in the commercial vehicle operation system of the present embodiment, when a vehicle that has a preceding user that is currently on board or has already made a reservation to board is selected as the desired carpool vehicle to be dispatched, and the fellow passenger to join the ride requests assistance, such as for boarding/deboarding, the preceding user is issued a consultation notification regarding whether to accept or refuse to provide assistive work to the fellow passenger. This has the effect of increasing the likelihood of the user using the system.

Further, in the commercial vehicle operation system of the present embodiment, when the preceding user determines whether to accept or refuse the consultation to provide assistive work to a fellow passenger, perk information, such as reduction in the usage fee or a discount coupon that can be used at the time of the next system usage or thereafter is presented to the preceding user as compensation for the assistive work. This has the effect of encouraging the preceding users to proactively consent to the assistive work for fellow passengers with whom the ride is shared.

In addition, in the commercial vehicle operation system of the present embodiment, the user is presented with information relating to the assistant, including at least one of gender, age, and languages spoken, as it pertains to an assistant managed by the server, a driver who also serves as an assistant, and a preceding user in the case that the preceding user is willing to provide assistance in a carpooling vehicle. As a result, the user feels more cooperative, and it is possible for the user to select a vehicle that can provide an assistive work service that is more suitable to the user's tastes.

In addition, in the commercial vehicle operation system of the present embodiment, if the user desires assistive work when requesting to use the present operation system, even if a commercial vehicle in which an assistant is on board or assistive equipment is installed is not present in the vicinity, a command is output to pick up an assistant or assistive equipment in the middle of the route on which the dispatch vehicle travels to the user's boarding location or destination. Alternatively, the commercial vehicle operation system issues an instruction to the assistant/assistive equipment waiting to provide work to move or be moved directly to the user's boarding location or destination. This has the effect of increasing the likelihood that the user will enjoy the commercial vehicle operation system.

Further, the commercial vehicle operation system of the present embodiment confirms with the user whether the user wishes to travel to the destination with the assistant who assisted riding along as a fellow passenger. It is thereby possible to meet various needs of the user, such as the user wishing to move by himself or herself during boarding, wishing to move comfortably without spatial restrictions in the vehicle, wanting someone to talk with during transport, and wanting to receive assistance in the event of an unforeseen situation.

Moreover, in the commercial vehicle operation system of the present embodiment, when there is a plurality of candidate vehicles that can be dispatched, such as a commercial vehicle in which an assistant is riding or assistive equipment is mounted, a commercial vehicle that picks up an assistant/assistive equipment on the way to the user's boarding location or destination, and a commercial vehicle that moves independently of the assistant and is joined at the user's boarding location or destination, information relating to the candidate vehicle is presented to the user in the order of fastest provision of service. This has the effect of making it easier for users to enjoy the service as soon as possible.

In addition, in the commercial vehicle operation system of the present embodiment, the vehicles managed by the system are either unmanned operation vehicles which are operated and managed in an unmanned manner by means of an autonomous driving function, or manned operation vehicles which are operated and managed by dedicated drivers in a manned manner, such as a taxi, and information is presented to the user such that it is possible for the user to understand whether the dispatch candidate vehicle is an unmanned operation vehicle or a manned operation vehicle. As a result, the user can request a vehicle to be dispatched that suits the user's preferences, which is effective in increasing the user satisfaction with the system.

In the present specification, a commercial vehicle operation system including the server 1, the unmanned operation vehicle 2, the manned operation vehicle 3, the user terminal 4, the preceding user terminal 5, the assistant's terminal 6, and the assistive equipment 7 according to the present invention was described as an example, but the present invention is not limited in this way.

In the present embodiment, the user information database 123DB shown in FIG. 1 may accumulate as information relating to the preceding user, information such as a history of consent to carpooling if the preceding user used the service in the past, and a history of whether the preceding user consented to assistive work when carpooling. Then, based on the consent history, the carpooling consultation notification unit 135 shown in FIG. 1 may preferentially send a carpooling consultation notification to preceding user terminals 5 of preceding users with a larger number of consents with respect to carpooling or a higher percentage of consent. In addition, based on the assistive work consent history, the fellow passenger assistive work consultation notification unit 143 shown in FIG. 1 may preferentially send a notification of fellow passenger assistive work consultation to preceding user terminals 5 of preceding users with a larger number of consents with respect to assistive work or a higher percentage of consent at the time of carpooling. As a result, the server 1 can efficiently calculate the vehicle desired by the user who requests carpooling and assistive work.

1. A commercial vehicle operation system provided with a server configured to communicate with an assistive work service providing vehicle equipped with an assistant's terminal possessed by an assistant who carries out assistive work or with assistive equipment that executes the assistive work, and a vehicle that is not equipped with an assistant's terminal or assistive equipment, and that selects a candidate vehicle and issues an instruction for a vehicle to be dispatched to a user, comprising:
a user information acquisition unit that acquires user information including at least the necessity of assistive work;
a vehicle operation information acquisition unit that acquires at least vehicle operation information relating to a current location of a vehicle under system management, current usage status, and availability of assistive work service;
a candidate vehicle extraction unit that extracts a dispatch candidate vehicle based on the user information and the vehicle operation information; and
a vehicle selection notification unit that presents the vehicle operation information of the extracted dispatch candidate vehicles and assistant information relating to the assistant to the user terminal possessed by the user,
the dispatch candidate vehicle being dispatched to the user's boarding location.

2. The commercial vehicle operation system according to claim 1, wherein
the candidate vehicle extraction unit extracts a plurality of the dispatch candidate vehicles, and
the vehicle selection notification unit that presents the vehicle operation information of the plurality of extracted dispatch candidate vehicles and the assistant information to the user terminal, and
the server dispatches the vehicle selected by the user to the user's boarding location.

3. The commercial vehicle operation system according to claim 2, wherein
the user information acquisition unit acquires information relating to the necessity of assistive work during boarding and/or deboarding.

4. The commercial vehicle operation system according to claim 3, further comprising
a carpooling request information acquisition unit that acquires request information regarding whether the user desires carpooling from the user terminal, and
if the user desires carpooling, a candidate vehicle capable of carpooling is extracted.

5. The commercial vehicle operation system according to claim 4, further comprising
a carpooling consultation notification unit that sends a notification to a preceding user terminal of a preceding user who is currently on board, or has already made a reservation to board a candidate vehicle capable of carpooling of a carpooling consultation regarding whether to accept or refuse carpooling with the user, and
a carpooling consultation result reception unit that receives the result of acceptance or refusal with respect to the carpooling consultation transmission from the preceding user terminal.

6. The commercial vehicle operation system according to claim 5, further comprising
a consent history of the preceding user with respect to carpooling is collected from a user information database, which accumulates information relating to the user and the preceding user, and
the carpooling consultation notification unit preferentially sends the carpooling consultation notification to the preceding user terminals of preceding users with a larger number of consents with respect to carpooling or a higher percentage of consent based on the consent history.

7. The commercial vehicle operation system according to claim 5, further comprising
a fellow passenger assistive work consultation notification unit that notifies the preceding user terminal of a fellow passenger assistive work consultation regarding whether the preceding user accepts or refuses to provide assistive work to the user who later joins the ride, and
a fellow passenger assistive work consultation result reception unit that receives the result of acceptance or refusal with respect to the fellow passenger assistive work consultation transmitted from the preceding user terminal, wherein
when the preceding user accepts the fellow passenger assistive work consultation, the candidate vehicle extraction unit extracts the vehicle used by the preceding user as a candidate vehicle that is capable of assistive work.

8. The commercial vehicle operation system according to claim 7, wherein
an assistive work consent history of the preceding user with respect to assistive work at the time of carpooling, from a user information database, which accumulates information relating to the user and the preceding user, and
the fellow passenger assistive work consultation notification unit preferentially sends the fellow passenger assistive work consultation notification to the preceding user terminals of preceding users with a larger number of consents with respect to assistive work or a higher consent percentage based on the assistive work consent history.

9. The commercial vehicle operation system according to claim 7, further comprising
a fellow passenger assistive work compensation calculation unit that calculates, as compensation for assistive work when the preceding user consents to providing the assistive work to the user, a reduction in charge of the usage fee for the preceding user or a reduction in charge of a discount coupon for reducing the fee for using the commercial vehicle operation system the next or a subsequent time, and
the fellow passenger assistive work consultation notification and present information on the reduced usage fee or information on the discount coupon is sent to the preceding user terminal.

10. The commercial vehicle operation system according to claim 9, wherein
the assistant information is information relating to at least one of gender, age, and languages spoken, of the assistant, a driver who also serves as an assistant, and a preceding user who has consented to the fellow passenger assistive work.

11. The commercial vehicle operation system according to claim 1, further comprising
an assistant/assistive equipment arrangement command notification unit that issues an assistive work command notification to the assistant's terminal, as well as a command for the assistant to be picked up in the middle of a route on which a dispatch vehicle selected by the user travels to the user's boarding location or destination, or a command to directly move to the user's boarding location or destination independently of the dispatch vehicle, and
if the assistant/assistive equipment arrangement command notification unit outputs a command to pick up an assistant or assistive equipment mid-route, the dispatch vehicle travels to a location to pick up the assistant or the assistive equipment.

12. The commercial vehicle operation system according to claim 2, further comprising
an assistant ride-share possibility information acquisition unit that acquires assistant ride-share possibility information regarding whether the user would like to ride-share with an assistant, and
a command to board the vehicle after the assistive work, or a command to deboard after the assistive work, is issued to the assistant's terminal in accordance with the assistant ride-share possibility information and the vehicle operation information.

13. The commercial vehicle operation system according to claim 2, wherein
the dispatch candidate vehicles are presented to the user terminal in an order of earliest arrival time to the user's destination.

14. The commercial vehicle operation system according to claim 1, wherein
the vehicle managed by the commercial vehicle operation system is either a manned operation vehicle that is driven by a person, or an unmanned operation vehicle provided with an autonomous driving function that travels autonomously in an unmanned manner.

15. The commercial vehicle operation system according to claim 1, wherein
the assistant information relating to at least one of gender, age, and languages spoken, of the assistant.

16. The commercial vehicle operation system according to claim 1, wherein
the user information acquisition unit is configured to acquire the user information including at least the necessity of the assistive work.
